(19) United States
(12) Patent Application Publication
(10) Pub. No.: US 2008/0197668 A1
(43) Pub. Date: Aug. 21, 2008

(54) Traffic control trailer

(76) Inventor: John M. Allovio, Waco, TX (US)

Correspondence Address: Mr. Christopher John Rourk;Jackson Walker LLP, 901 Main Street, Suite 6000, DALLAS, TX, 75202, US

(21) Appl. No.: 11/708,405

(22) Filed: Feb. 20, 2007

(51) Int. Cl. B62D 63/06; B62D 21/18; G06F 7/00

(52) U.S. Cl. 296/181.1; 280/402; 342/104; 701/48

(57) ABSTRACT

A traffic control trailer is provided. The traffic control trailer includes a three-dimensional patrol car body section, which appears to an approaching motorist to be a patrol car regardless of naturally-occurring terrain and road conditions. A plurality of systems simulate actions performed by a law enforcement patrol car, such as turning on a light bar or activating a speed detection radar.

### FIELD OF THE INVENTION

The present invention pertains to the field of traffic safety, and more specifically to a traffic control trailer that creates a realistic deterrent to speeding and increases motorist attention to traffic conditions.

### BACKGROUND OF THE INVENTION

Prior art systems and methods for creating a patrol car decoy include parking an actual patrol car or using a two dimensional decoy at a road construction site or other locations where the presence of a patrol car will help to deter speeding and increase motorist attention to traffic conditions. While such prior art systems and methods help to indicate the need for solutions other than having an actual patrol car present, there are numerous problems with such prior art systems and methods.

For example, if an actual patrol car is used, then the cost incurred is significant, both in the unavailability of an operating patrol car and in the time required to have the patrol car transported to the location where it is being deployed. Furthermore, an unmanned patrol car either must have its lights on permanently, which wastes energy, or must be quiescent, which detracts from its deterrent value.

Likewise, if a two dimensional decoy is used, motorists can usually determine that the decoy is not an actual patrol car. While such decoys can be readily deployed, they are generally ineffective at deterring speeding or increasing motorist attention to traffic conditions. In addition, such decoys have limited ability to provide other safety or traffic control functions.

### SUMMARY OF THE INVENTION

In accordance with the present invention, a traffic control trailer is provided that deters speeding and increases motorist attention to traffic conditions.

In particular, a traffic control trailer is provided that provides functional performance to simulate a patrol car as well as other important traffic safety features.

In accordance with an exemplary embodiment of the present invention, a traffic control trailer is provided. The traffic control trailer includes a three-dimensional patrol car body section, which appears to an approaching motorist to be a patrol car regardless of naturally-occurring terrain and road conditions. A plurality of systems simulate actions performed by a law enforcement patrol car, such as turning on a light bar or activating a speed detection radar.

The present invention provides many important technical advantages. One important technical advantage of the present invention is a traffic control trailer that simulates a three-dimensional portion of a patrol car so as to better simulate the appearance of a patrol car.

Those skilled in the art will further appreciate the advantages and superior features of the invention together with other important aspects thereof on reading the detailed description that follows in conjunction with the drawings.

### BRIEF DESCRIPTION OF THE DRAWINGS

FIG. 1 is a diagram of a traffic control trailer in accordance with exemplary embodiment of the present invention;

FIG. 2 is a diagram of a traffic control trailer system in accordance with an exemplary embodiment of present invention;

FIG. 3 is a diagram of an anchor system in accordance with an exemplary embodiment of the present invention;

FIG. 4 is a diagram of a system for controlling displays and lights on a traffic control trailer in accordance with an exemplary embodiment of the present invention; and

FIG. 5 is a diagram of a method for controlling a traffic control trailer in accordance with an exemplary embodiment of the present invention.

### DETAILED DESCRIPTION OF PREFERRED EMBODIMENTS

In the description that follows, like parts are marked throughout the specification and drawings with the same reference numerals. The drawing figures might not be to scale and certain components can be shown in generalized or schematic form and identified by commercial designations in the interest of clarity and conciseness.

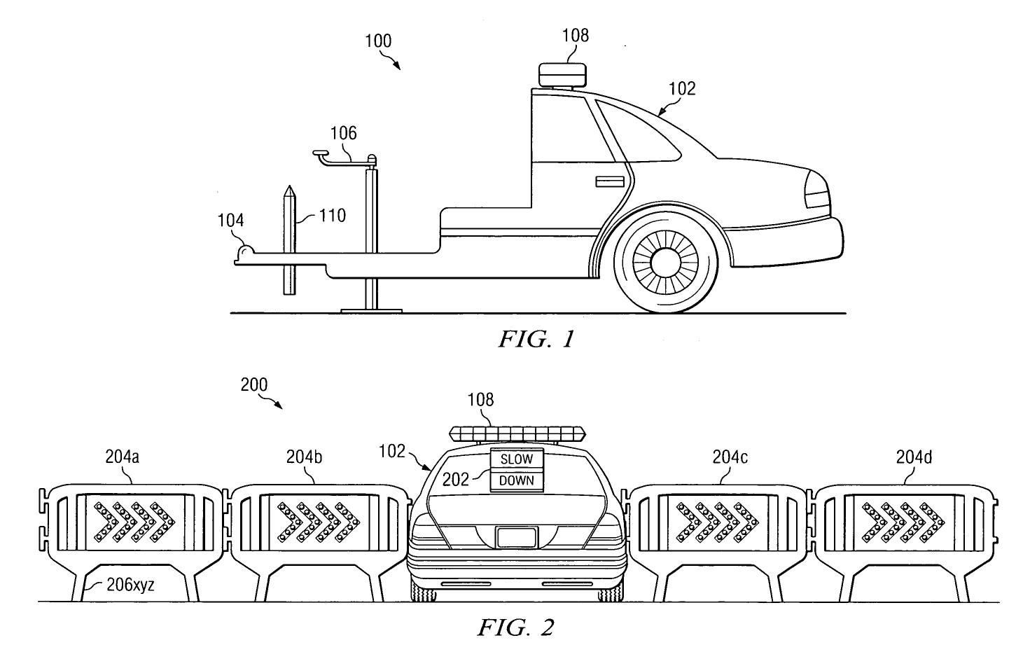

FIG. 1 is a diagram of traffic control trailer 100 in accordance with exemplary embodiment of the present invention. Traffic control trailer 100 allows a trailer to be deployed instead of a live patrol car for traffic control purposes.

Traffic control trailer 100 includes patrol car body 102, which is a portion of a police or other emergency vehicle. In one exemplary embodiment, patrol car body 102 can be a simulated patrol car body, a decommissioned patrol car body that has been cut away to reduce the size and weight of patrol car body or other suitable patrol car bodies.

Trailer hitch 104 is connected to patrol car body 102 by a frame (not explicitly shown). Adjustable support 106 allows trailer hitch 104 to be elevated so as to avoid contact with the ground and potential damage. Storage spike 110 is used to store the plurality of traffic cones (not explicitly shown), such as may be required at a site where traffic control trailer 100 is deployed. Light bar 108 is a three dimensional reproduction of a police or patrol car light bar, such as with flashing lights and other suitable lights.

In operation, traffic control trailer 100 creates the appearance of a law enforcement patrol car from a distance. Traffic control trailer 100 includes three dimensional elements such as patrol car body 102 and light bar 108 that help to create the illusion of an actual patrol car from a distance, such as where slight bends or curvature of the road may allow motorists to determine the difference between a two dimensional decoy and a three dimensional trailer. As such, while traffic control trailer 100 requires additional fabrication and materials when compared to a two dimensional decoy, traffic control trailer 100 creates a more realistic and therefore more effective apparatus for the purposes of deterring motorists' non-compliance with traffic regulations and gaining motorists' attention of traffic control trailer 100.

FIG. 2 is a diagram of traffic control trailer system 200 in accordance with an exemplary embodiment of present invention. Traffic control trailer system 200 includes additional indication panels and other devices to provide motorists with information, and to also obscure the portions of the patrol car 102 that do not represent an actual patrol car.

Trailer control trailer system 200 includes patrol car body 102 and signal panels 202 and 204A through 204D. Each signal panel 202 and 204A through 204D can include fixed lights, programmable LED lights, or other suitable displays. Displays 204A through 204D extend from the sides of patrol car body 102, such as at the point at which patrol car body 102 terminates. In this manner, panels 204A through 204D help to obscure the portion of the patrol car body 102 beyond that section which resembles an actual patrol car, so that approaching motorists are prevented from determining that patrol car body 102 is not an actual patrol car.

In addition, display panels 202 and 204A through 204D can be programmable LED panels. In this exemplary embodiment, a series of preset programs can be used to provide arrows directing traffic to move left or right, providing traffic update information, or other suitable information. Likewise, user-programmable messages can be entered and displayed, traffic update data can be received from a traffic control center and displayed, vehicle speed data can be received from a radar speed detection system and displayed, or other suitable information can also or alternatively be provided.

Each display panel 204A through 204D includes adjustable legs 206. These adjustable legs allow the position of each display panel 204A through 204D to be adjusted to fit uneven terrain.

In an another exemplary embodiment, the message displayed on display panels 202 or 204A through 204D can be coordinated with a radar speed detection device maintained within patrol car body 102. In this exemplary embodiment, the motorists' speed can be displayed on one or more of display panels 204A through 204D or 202.

In operation, traffic control trailer system 202 allows traffic control trailer 102 to be deployed in a manner that increases the likelihood that a motorist will believe that an actual patrol car is present. In this manner, the front portions of the traffic control trailer 102 are obscured by display panels 204A through 204D. Likewise, display panel 202 also creates a distraction to motorists, causing them to pay attention to something other than traffic control trailer 102. In this manner, motorists will generally perceive that traffic control trailer 102 is a police car or other emergency vehicle and will respond accordingly to obey traffic regulations or laws.

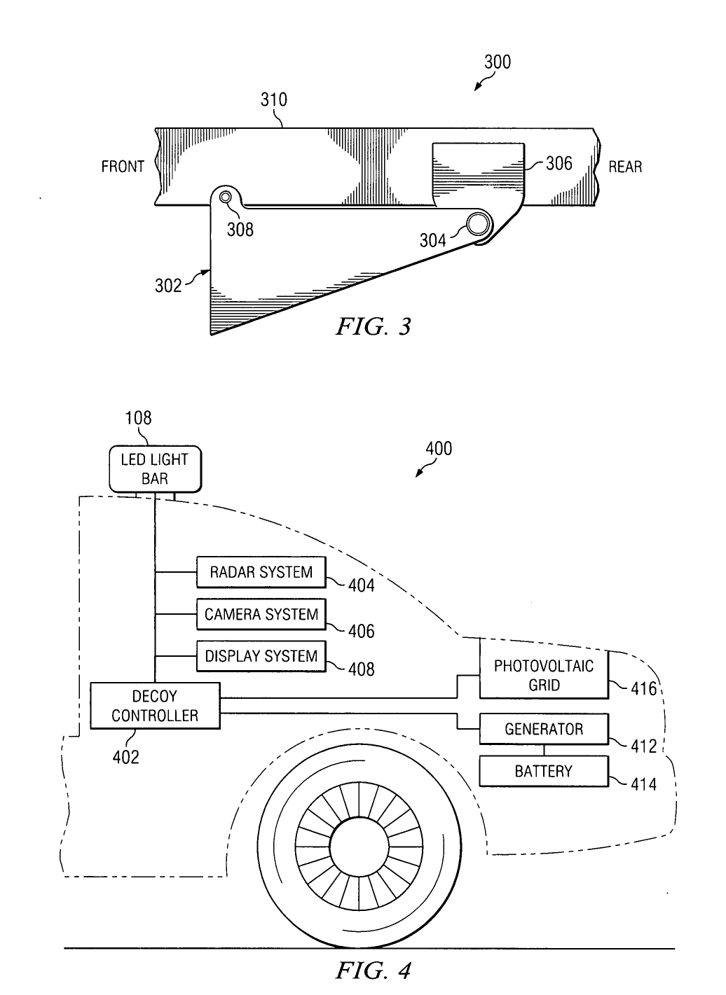

FIG. 3 is a diagram of anchor system 300 in accordance with an exemplary embodiment of the present invention. Anchor system 300 is an anti-roll device that can be provided with traffic control trailer 100 or other suitable apparatuses so as to mitigate the probability of damage occurring from a rear end collision with the traffic control trailer 100 or other objects.

System 300 includes anchor 302, which is connected to trailer frame 310 by hinge 304 and clevis pins 308. In one exemplary embodiment, anchor 302 can be placed in a first position while traffic control trailer 100 or other suitable items are being transported, and can be placed in a second position as shown in FIG. 3 for use in the field. When anchor 302 is deployed, a rear end collision with traffic control trailer 100 will cause the edge of anchor 302 to drive into the ground. In this manner, trailer frame 310 will tilt forward and prevent traffic control trailer 100 or other items attached to trailer frame 310 from proceeding in the direction of vehicle movement. Thus, an inattentive motorist or disabled motorist who runs into traffic control trailer 100 or other items will not continue on, with the possibility of causing injury or damage to workers or equipment, but will instead become entangled in trailer frame 310, which will be anchored in location. In this manner, the damage caused an inattentive motorist can be mitigated so as to prevent injury or damage to others.

FIG. 4 is a diagram of system 400 for controlling displays and lights on a traffic control trailer in accordance with an exemplary embodiment of the present invention.

System 400 includes trailer controller 402, which can be implemented in hardware, software, or a suitable combination of hardware and software, which can be one or more software systems operating on a general purpose processing platform. Trailer controller 402 controls the operation of radar system 404, camera system 406, display system 408 and communication system 410.

Radar system 404 generates a vehicle speed detecting radar signal and measures the speed of a plurality of vehicles. In one exemplary embodiment, radar system 404 can generate speed data that is used by trailer controller 402 to operate camera system 406, display system 408, light bar 108, or other suitable systems. Likewise, camera system 406 can turn on radar system 404 as described below. In another exemplary embodiment, one or more systems can be operated when a first speed range is detected, such as from 1 to 10 miles per hour over a user-entered speed limit, and one or more additional systems can be operated for detected speed ranges over the first speed range. In this exemplary embodiment, light bar 108 can be operated when a vehicular speed in the first range is detected, and camera system 406 and communication system 410 can be operated when a vehicular speed in excess of the first range is detected, such as to generated video evidence and to notify patrol cars of the speeding vehicle.

Camera system 406 generates image data of vehicles approaching the traffic control trailer using system 400. In one exemplary embodiment, camera system 406 can be coordinated with radar system 404 so as to operate only when vehicles are approaching. Likewise, camera system 406 can be used in conjunction with radar system 404, such as to generate a time stamped entry to allow radar data generated by radar system 404 to be used as evidence for enforcing traffic regulations against vehicles captured by camera system 406, to turn radar system 404 on if movement is detected, or to perform other suitable functions.

Display system 408 controls information or operation on display panels (not explicitly shown). In one exemplary embodiment, trailer controller 402 can include a keyboard and terminal screen that allows a user to enter a display, select between preprogrammed displays, or make other suitable display selections. Display system 408 transmits control data to lights such as LEDs or other suitable lights to cause a display to operate. In one exemplary embodiment, display system 408 can generate a speed generated by radar system 404, such as to alert a motorist as to its speed as detected. In another exemplary embodiment, display system 408 can cause light bar 108 to operate when radar system 404 detects a speed over a lawful speed limit, such as to generate the appearance that the traffic control trailer 400 is an actual patrol car that has turned on its lights because of a detected speeder.

Communication system 410 communicates with a remote operator in response to control data received from trailer controller 402. In one exemplary, trailer controller 402 can notify one or more patrol cars of detected vehicle speeds in excess of the speed limit, so as to alert them to watch for the speeding vehicles. Communication system 410 can also notify an operator when an equipment malfunction is detected by trailer controller 402, such as the failure of a power source, a display panel (such as due to age, wear, a collision or vandalism), or other equipment. Communication system 410 can also include user controls to allow a user to communicate with patrol cars, a dispatcher, the Internet, or other suitable persons or systems, such upon entry of a user password, receipt of a mechanical key, or in other suitable manners.

Photovoltaic grid 416 and generator 412 are coupled to trailer controller 402, and can provide power to radar system 404, camera system 406, display system 408, as well as trailer controller 402. In one exemplary embodiment, photovoltaic grid 410 can be used when incident sunlight is sufficient to generate power to operate trailer controller 402 and any other related systems. Likewise, trailer controller 402 can cause generator 412 to operate so as to generate electric power for operation. Likewise, generator 412 can be controlled to provide energy to run system 400 and charge battery 414, such that battery 414 is charged when photovoltaic grid 410 is not generating sufficient energy to run trailer controller 402.

In operation, system 400 controls one or more related systems of a traffic control trailer so as to provide for power management, operation of a radar system 404, camera system 406, display system 408, light bar 408, or other suitable systems. In this manner, traffic control trailer 100 can be operated so as to create a more realistic impression of the presence of a patrol car, to generate evidence for use in prosecuting traffic violators, or for other suitable purposes.

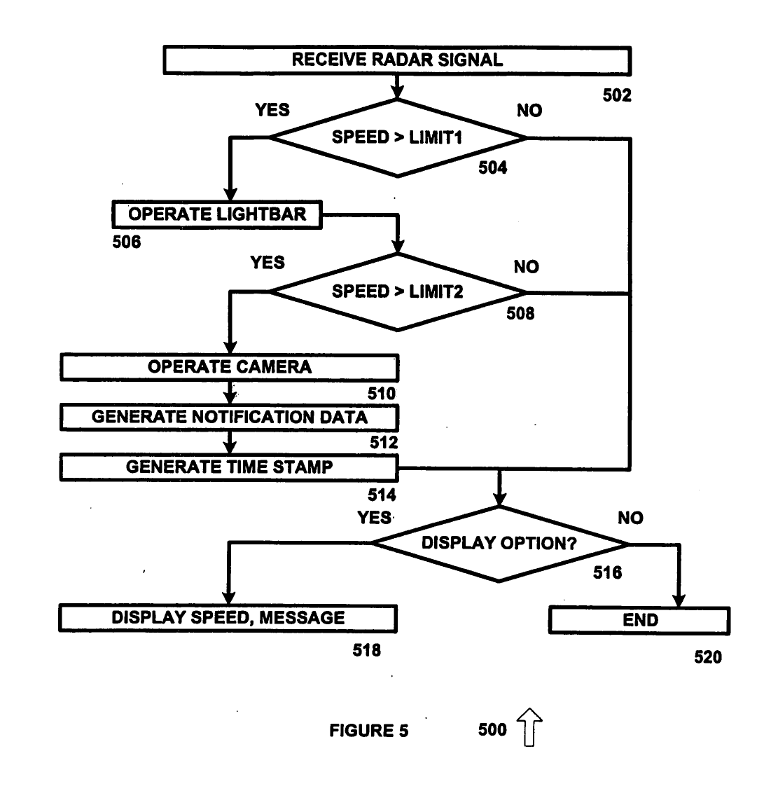

FIG. 5 is a diagram of method 500 for controlling a traffic control trailer in accordance with an exemplary embodiment of the present invention. Method 500 begins at 502 where a radar signal is received. In one exemplary embodiment, the radar signal can be generated by the traffic control trailer and can be used to detect the presence of people traveling in excess of the posted speed limits. In another exemplary embodiment, a camera or other suitable motion detector can first be used to turn the radar signal generator, after which the speed is detected, such as where the energy used to run the motion detector is less than the energy required to generate the radar signal. The method then proceeds to 504.

At 504, it is determined whether the detected speed is greater than the first predetermined speed limit, such as 5 miles over the speed limit. If the detected speed is not greater than the first detected speed limit, the method proceeds to 516. Otherwise, the method proceeds to 506 where a light bar or other suitable equipment is operated. In one exemplary embodiment, the light bar can be a light bar on top of a traffic control trailer so as to generate the appearance that a police car has detected a speeder as is entering traffic to issue a violation. The method then proceeds to 508.

At 508, it is determined whether a speed is greater than a second speed limit, such as 10 miles over the posted limits or other suitable limits. If the speed is not greater than the second limit the method proceeds to 516. Otherwise, the method proceeds to 510 where a camera is operated if the camera system is not presently operating, such as to capture images of the speeding vehicles. The method then proceeds to 512 where notification data is generated, such as to notify patrol officers in the area of a speeding vehicle. The method then proceeds to 514 where time stamp data, radar speed data or other suitable data is generated and added to the camera image. In one exemplary embodiment, the time stamp can be stored or other data can be indexed to the image data, so as to create a uniform record. Likewise, the time stamp, speed or other suitable data can be added to the image data. The method then proceeds to 516.

At 516, it is determined whether a display option has been selected. If the display option has not been selected, the method proceeds to 520 and terminates. Otherwise, the method proceeds to 518 where the speed, a message, or other suitable data is displayed. In one exemplary embodiment, a speeder can be notified of his speed, a message such as slow down, please pull over for the patrol vehicle, or other suitable messages can be generated. Likewise, when detected speeds are within allowed speed limits, a sign such as “thank you for not speeding” or other suitable indications can be generated. In addition, if traffic signals such as indicating directions for traffic to merge or other suitable information are provided, the message can be displayed only when vehicles are detected to be present, so as to conserve hour, equipment wear, and other resources.

Although exemplary embodiments of a system and method of the present invention have been described in detail herein, those skilled in the art will also recognize that various substitutions and modifications can be made to the systems and methods without departing from the scope and spirit of the appended claims.

What is claimed is:

1. A traffic control trailer comprising:
a three-dimensional patrol car body section; and
a plurality of systems simulating actions performed by a law enforcement patrol car.

2. The traffic control trailer of claim 1 wherein the plurality of systems comprise a light bar simulator simulating a law enforcement patrol car light bar.

3. The traffic control trailer of claim 1 wherein the plurality of systems comprise a radar system simulating a law enforcement radar speed detector.

4. The traffic control trailer of claim 1 further comprising a camera system recording video data of traffic.

5. The traffic control trailer of claim 1 further comprising a control system controlling the plurality of simulator systems.

6. The traffic control trailer of claim 1 further comprising an anti-roll device inhibiting movement of the traffic control trailer.

7. The traffic control trailer of claim 1 further comprising a plurality of display panels generating traffic control display data.

8. A traffic control trailer comprising:
patrol car body means for simulating the appearance of a patrol car; and
a plurality of simulator systems simulating actions performed by a law enforcement patrol car.

9. The traffic control trailer of claim 8 wherein the plurality of simulator systems comprise light bar means for simulating a law enforcement patrol car light bar.

10. The traffic control trailer of claim 8 wherein the plurality of simulator systems comprise radar means for simulating a law enforcement radar speed detector.

11. The traffic control trailer of claim 8 further comprising camera means for recording video data of traffic.

12. The traffic control trailer of claim 8 further comprising control means for controlling the plurality of simulator systems.

13. The traffic control trailer of claim 1 further comprising anti-roll means for inhibiting movement of the traffic control trailer.

14. The traffic control trailer of claim 1 further comprising display means for generating traffic control display data.

15. A method for controlling a traffic control trailer comprising:
receiving radar data at a control system;
determining whether to perform a control action for one or more of a plurality of systems based on the radar data;
generating control data; and
wherein the control system is separate from the plurality of systems.

16. The method of claim 15 wherein determining whether to perform the control action for one or more of the plurality of systems comprises determining whether to perform the control action for one of two or more of a light bar system, a display panel system, a camera system, and a communication system.

17. The method of claim 15 wherein determining whether to perform the control action for one or more of the plurality of systems comprises:
generating control data for a first system if a detected speed is greater than a first predetermined speed; and
generating control data for a second system if a detected speed is greater than a second predetermined system.

18. The method of claim 15 wherein determining whether to perform the control action for one or more of the plurality of systems based on the radar data comprises determining whether to activate a display if a vehicle is detected traveling at any detectable speed.
